(19) United States
(12) Patent Application Publication
(10) Pub. No.: US 2008/0212495 A1
(43) Pub. Date: Sep. 4, 2008

(54) Configuration mechanism in hosted remote access environments

(75) Inventor: Vlad Stirbu, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/011,085

(22) Filed: Jan. 23, 2008

Related U.S. Application Data
(60) Provisional application No. 60/881,902, filed on Jan. 23, 2007.

(51) Int. Cl. H04L 12/28

(52) U.S. Cl. 370/254

(57) ABSTRACT

In the exemplary embodiments of the invention there is a method including setting up a first tunnel between a first device and a remote access relay, setting up a second tunnel between the remote access relay and a remote access server, and updating the first device with related parameters and settings on the remote access relay.

### CROSS-REFERENCE TO RELATED APPLICATIONS

This patent application claims priority under 35 U.S.C. §119(e) from Provisional Patent Application No. 60/881,902, filed Jan. 23, 2007, the disclosure of which is incorporated by reference herein in its entirety.

### TECHNICAL FIELD

The teachings in accordance with the exemplary embodiments of this invention relate generally to a configuration mechanism in hosted remote access environments. More particularly, the exemplary embodiments of this invention relate to configuration of the network connectivity between two or more universal plug and play (UPnP) devices when there is a remote access relay hosted by a third party.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

UPnP technology (www.upnp.org) defines an architecture for pervasive peer-to-peer network connectivity of UPnP devices, such as intelligent appliances, wireless devices, and PCs of all form factors. It defines a family of protocols for automatically configuring devices, discovering services, and providing peer-to-peer data transfer over an IP network. UPnP technology is designed to bring easy-to-use, flexible, standards-based connectivity to ad-hoc or unmanaged networks, whether in home, in a small business, public spaces, or attached to the Internet. It provides a distributed, open networking architecture that leverages TCP/IP and the Web technologies to enable seamless proximity networking in addition to control and data transfer among networked devices.

The UPnP Device Architecture (UDA), defined by UPnP forum and available from the UPnP forum website, is designed to support zero-configuration, “invisible” networking, and automatic discovery for a breadth of device categories from a wide range of vendors. This means a device can dynamically join a network, obtain an IP address, convey its capabilities, and learn about the presence and capabilities of other devices.

A paper submitted within the UPnP Forum entitled “UPnP Remote Access Architecture draft v1.0”, defines Remote Access Architecture which enables a remote UPnP device or UPnP Control point to connect to the home network and to interact with the UPnP entities physically attached to the home network. During this process it is expected that the remote user experiences the remote device behaving in a similar way as in the home network.

Another paper submitted within the UPnP Forum entitled, “UPnP Remote Access Transport Agent (RATA) Config:1 Service”, defines a UPnP service (RATAConfig) that allows control points to provision and configure the parameters that are required for enabling a Remote Access Server (RAS) to accept and a remote Access Client (RAC) to initiate remote access connection.

A technical report entitled “DSL Forum TR-69, CPE Wide Area Network (WAN) Management Protocol,” is a specification describing the DSL customer premises equipment (CPE) WAN Management Protocol, intended for communication between a CPE and Auto-Configuration Server (ACS). The CPE WAN Management Protocol defines a mechanism that encompasses secure auto-configuration of a CPE, and also incorporates other CPE management functions into a common framework.

The lack of available public Internet Protocol version 4 (IPv4) addresses is one of the reasons that the Internet Service Providers (ISPs) allocate private IPv4 addresses on the WAN interface of their subscriber's residential routers. This situation creates a problem for enabling Remote Access to UPnP home networks because this usage scenario requires the residential gateway to be reachable from the public internet (e.g. public routable IP address on the WAN interface). In order to overcome this problem, there is a need for a third party network element in the public Internet that allows the traffic from the Remote Access Client (RAC) to be relayed to the home Remote Access Server (RAS).

However the third party network relay solution raises several challenges from the UPnP point of view because UPnP promises zero-configuration. First, a problem is presented in how to set up the secure transport channels between the RAS, RAC and the RA Relay that is hosted in the ISP network. Second, once these tunnels are up and running, a further problem relates to how to allocate the network addresses (for example, IP addresses) so that the traffic can be routed between the RAC and the home UPnP device in an UPnP Device Architecture (UDA) compatible fashion. Accordingly, there is a need to define a new mechanism in the Hosted Remote Access environments.

### SUMMARY

In an exemplary aspect of the invention, there is a method comprising setting up a first tunnel between a first device and a remote access relay, setting up a second tunnel between the remote access relay and a remote access server, and updating the first device with related parameters and settings on the remote access relay.

In another exemplary aspect of the invention, there is a computer readable medium encoded with a computer program executable by a processor to perform actions comprising setting up a first tunnel between a first device and a remote access relay, setting up a second tunnel between the remote access relay and a remote access server, and updating the first device with related parameters and settings on the remote access relay.

In yet another exemplary aspect of the invention, there is an apparatus comprising a network interface, a memory, and a processor configured to set up a first tunnel between a first device and a remote access relay, the processor further configured to set up a second tunnel between the remote access relay and a remote access server, and the processor further configured to update the first device with related parameters and settings on the remote access relay.

In still another exemplary aspect of the invention, there is an apparatus comprising means for setting up a first tunnel between a first device and a remote access relay, means for setting up a second tunnel between the remote access relay and a remote access server, and means for updating the first device with related parameters and settings on the remote access relay.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows is a diagram of an example Hosted Remote Access environment;

FIG. 2 illustrates an example of how the secure tunnels are configured;

FIG. 3 illustrates an example of relay configuration message sequence;

FIG. 4 illustrates a Remote Access network elements roles in the address allocation mechanism;

FIG. 5 illustrates a perspective view of a mobile phone for which the exemplary embodiments of this invention can be used;

FIG. 6 illustrates a schematic representation of the circuit of the mobile phone in FIG. 5; and

FIG. 7 illustrates a method according to an exemplary embodiment of the invention.

### DETAILED DESCRIPTION

Various embodiments of the exemplary embodiments of this invention comprise a mechanism to setup the tunnels between the RAC, RAS and the Remote Access Relay hosted by the ISP and an address allocation mechanism that enable routing inside this overlay network in an UDA compatible fashion.

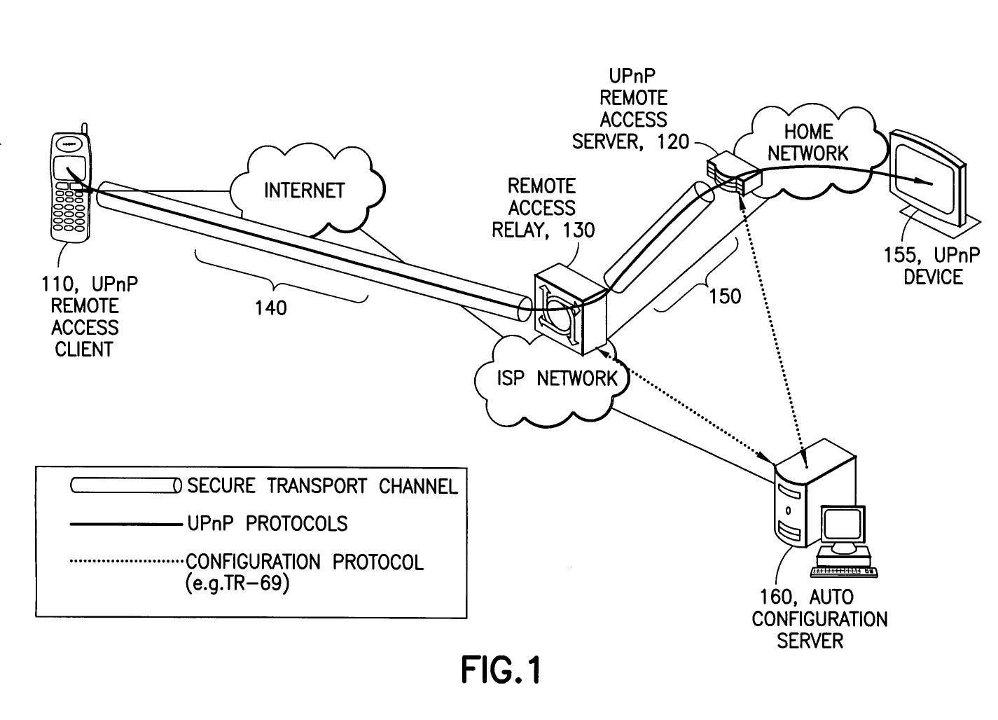

FIG. 1 shows a diagram of an example Hosted Remote Access environment with hosted third party infrastructure. In such an environment, the RAC 110 is able to connect to the RAS 120 only if the connection is mediated by a Remote Access Relay (RAR) 130 hosted by the ISP (or another third party). The reason for having this setup is because the RAS 120 does not have a public IP address and therefore is not reachable from the Internet. So, in order to have RAC-RAS connectivity, two tunnels 140,150 need to be established: one 140 from the RAC 110 to RAR 130 and another tunnel 150 form the RAS 120 to RAR 130.

The paper entitled “UPnP Remote Access Architecture draft v1.0” describes the scenario where the RAC 110 connects directly to the RAS 120 in the home network. In that scenario, the procedures for configuring the secure tunnels are described in the UPnP Remote Access Transport Agent configuration paper mentioned above. However, neither the Remote Access Architecture draft nor the Remote Access Transport Agent configuration paper discusses the situation when the Remote Access is mediated by the Remote Access Relay 130, as shown in FIG. 1. FIG. 1 also depicts an Auto Configuration Server (ACS) 160, and UPnP device 155 that is coupled through the RAS 120.

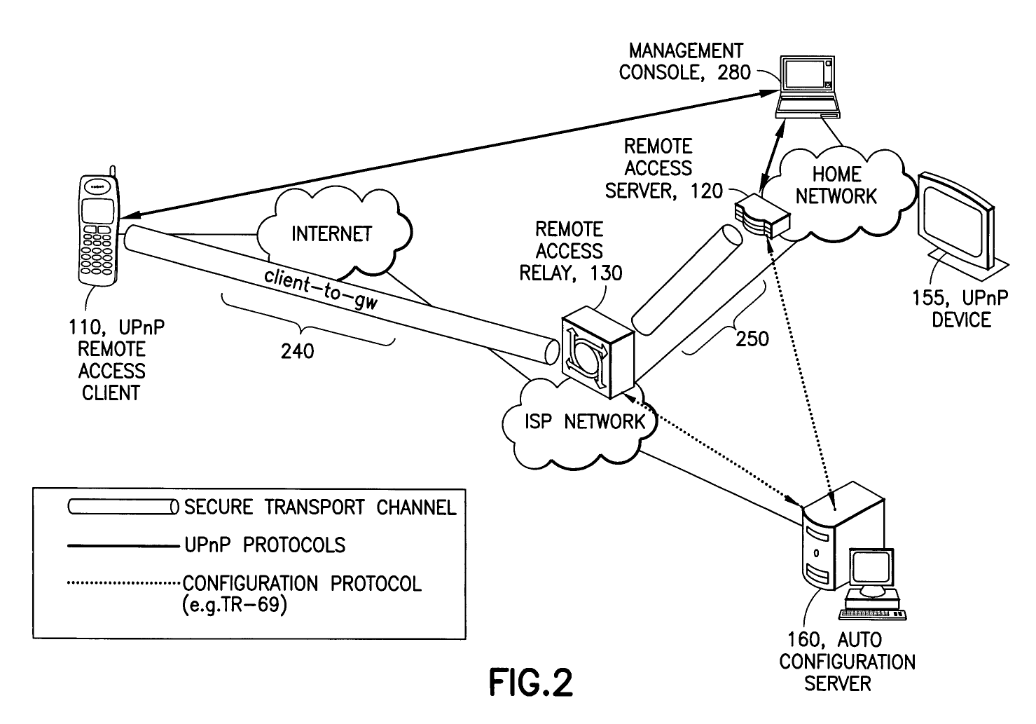

FIG. 2 shows an example of how the secure tunnels are configured. In FIG. 2, the connection between the RAC 110 and the UPnP device 155 is done via two tunnels: a gateway-to-gateway tunnel 250 from the RAS 120 to the RAR 130 and a client-to-gateway tunnel 240 from the RAC 110 to the RAR 130. As compared to the UPnP Remote Access architecture described above, this embodiment creates additional challenges, because in order to make the experience “plug-and-play”, i.e. zero-configuration, there is a need to configure an additional tunnel 250 between the RAS 220 and RAR 230 and to update the client with related parameters and settings on the RAR 130 so that the RAC device 110 can initiate Remote Access connections.

The configuration of the RAS-RAR tunnel 250 can be performed by the auto configuration server 160. The configuration process depends on the type of the infrastructure deployed in the ISP network. In the case of Digital Subscribe Line (DSL), the Internet Service Provider can configure the RAR 130 and the RAS 120 by using as a baseline the mechanisms defined in the TR-69 as described in the paper “DSL Forum TR-69, CPE Wide Area Network (WAN) Management Protocol.”

Each service in the UPnP device may contain any number of actions, each action having a set of input parameters and an optional return value. The action would include a name and possibly a set of arguments. Further, argument has a direction and the direction can be an input or an output, depending if the argument is passed into the action or if the argument is returned from the action to the caller. Further, there is a return value that provides the result of the action.

For each UPnP service there can be a service type Uniform Resource Identifier (URI) that identifies the service. Further, there are standard service types defined by a UPnP committee. For a service there is a serviceId URI that identifies the particular service of a device's services. There can be no two services that share the same serviceId. A device type determines the services that a device may implement.

In addition, a service can also maintain variables that represent a current status of the service. It can be noted that a service may have zero or more such variables. Further, each state variable has a name, a type, a default value, and a current value. Each state variable also has a set of allowed values that describe a range of permissible variable values, and state variables can trigger events upon state changes.

As described in the UPnP remote access transport agent paper and in accordance with an exemplary embodiment of the invention state variables can include string data type variables: RATAType, TransportAgentCapabilities, SupportedCredentialDelivery, CredentialsList, A_ARG_TYPE_ProfileList, A_ARG_TYPE_ProfileConfigInfo, StateVariableName1, and A_ARG_TYPE_StateVariableName3; and ui4 data type state variable StateVariableName2.

Further, according to the UPnP remote access transport agent paper an “allowedValueList” for an RATAType state variable can include values “RAClient”, “RAServer”, “Value3”, and/or a vendor defined state variable. Further, the “SupportedCredentialDelivery” and the “StateVariableName1” state variables can include “allowedValueList” values “Value1”, “Value2”, and “Value3”. In addition, according to the UPnP remote access transport agent paper an “allowedValueRange” for the “StateVariableName2” and the “A_ARG_TYPE_StateVariableName3” can include “Minimum value”, “Maximum value”, and “Increment”. It is further noted that any of these values can be replaced with a vendor specific value.

However, in order to be able to configure this Remote Access specific tunnel 250, new data models need to be defined to support the services defined by UPnP Remote Access Working Committee. For example, the configuration protocol used between the Auto Configuration Server 160 and RAR 130, RAS 120 needs to be able to configure multiple types of tunnels, e.g. IPsec, Transport Layer Security (TLS)/Secure Socket Layer (SSL) as in Open VPN, etc.

In order to make the user experience similar as if the RAC 110 connects directly to the RAS 120, the UPnP mechanisms defined in the UPnP Remote Access Architecture paper can be used. A Management Console (MC) 280, which is the collection of control points that are used to setup, manage and monitor the operations related to Remote Access, is able to configure the RAR 130 the same way as for RAS 120.

The Remote Access drafts in the UPnP Remote Access Architecture paper allows the MC 280 to configure the RAS 120 by indicating that the data structures exchanged are of type server. In order to enable the MC 280 to detect if the RAS 120 accepts connections via the RAR 130, a new RATA data structure type relay can be used. One example of this new data structure type can be expressed in XML, as shown below:

<?xml version=“1.0” encoding=“UTF-8”?>
<RATADT

xmlns=“urn:schemas-upnp-org:remoteaccess:ratadt”
xmlns:xsi=“http://www.w3.org/2001/XMLSchema-instance”
xsi:schemaLocation=“urn:schemas-upnp-org:ra:ratadt
http://www.upnp.org/schemas/ra/ratadt-v0.1-20060926.xsd”>
<dataStructureType>relay</dataStructureType>
<profileConfig>

<profile>

<transportAgentName>transport name</transportAgentName>
<profileDescription>friendly description</profileDescription>

</profile>
<profileData>

<!--Placeholder for defining data specific for each transport

mechanism. Data structures defined in another namespace-->

</profileData>

</profileConfig>

</RATADT>

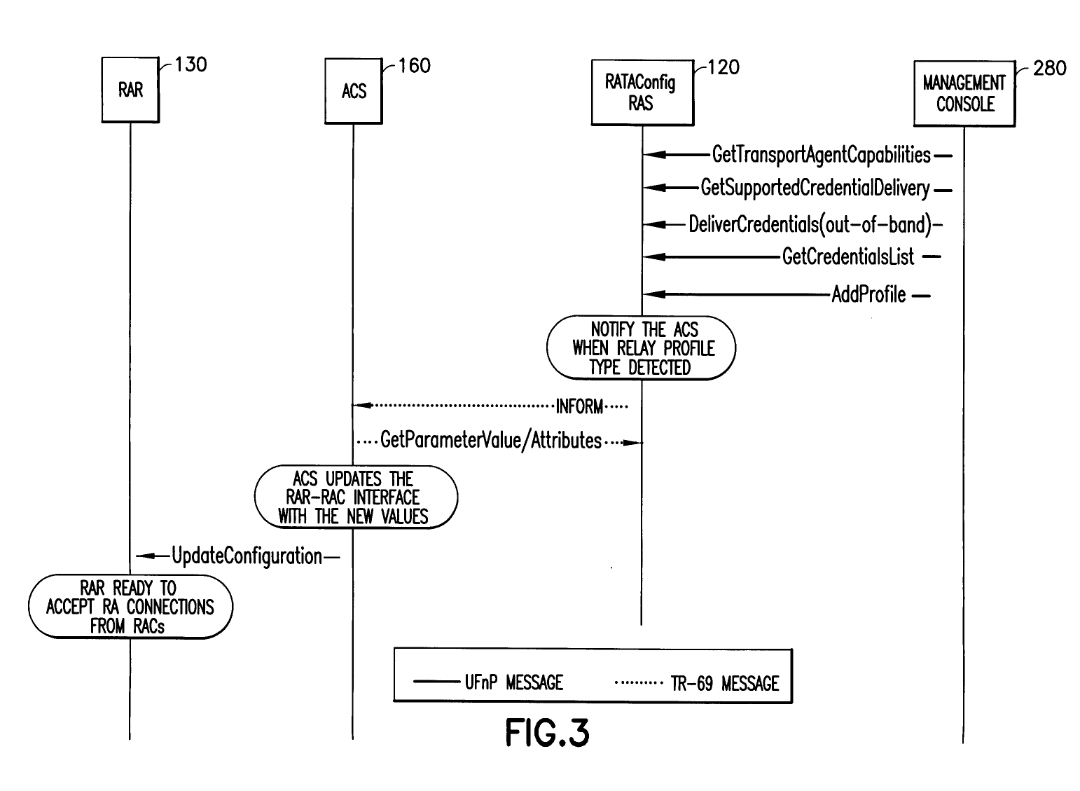

The new relay data structure type is similar in some respects as to content and functionality with the server data structure type defined in the “UPnP Remote Access Transport Agent (RATA) Config:1 Service” paper. However, and in accordance with exemplary embodiments of this invention, the effects of the configuration updates are seen on the RAR interface exposed to RAC 110 instead of the RAS 120. This difference can be seen in FIG. 3.

All changes applied on the Remote Accesses are propagated to the RAR 130 through, for example, the same configuration protocol used for configuring the RAS-RAR tunnel 250.

In FIG. 2, the RAR 130 needs to handle the IP address allocation in such a fashion that the RAC 110 has an IP address from the Home Network address pool, and traffic from one tunnel is forwarded to the other tunnel. It is possible that the two tunnels 240, 250 do not use the same enabling technology, e.g. one segment is provided by Open Virtual Private Network (VPN) and other by IP Security (IPSec), which is a security protocol from the Internet Engineering Task Force (IETF) that provides authentication and encryption over the internet. Therefore, the tunnels 240, 250 need to be configured in a “plug-and-play” fashion so that the user is not required to be aware of the complexity of the underlying architecture. Further, the IP addresses allocation needs to enable devices to communicate with each other in a UDA compatible fashion.

The RAC 110 cannot directly acquire an IP address from the home Dynamic Host Configuration Protocol (DHCP) server if the communication is done via the RAR hosted by a third party (such as an ISP), instead it has to rely on some functionality provided by the RAR 130. In one embodiment of this invention, RAR 130 acts as a DHCP relay agent and forwards the DHCP requests received from the RAC 110 to the RAS 120. In another embodiment of this invention, DHCP server functionality exists in the RAR 130 itself. If the DHCP server functionality exists in the RAR 130, the DHCP server in both the RAR 130 and the RAS 120 needs to be properly configured.

In one embodiment of this invention, the RAR 130 is acting as a DHCP relay and it is configured to forward all DHCP requests coming from the RAC 110 to the RAS 120. This way the RAC 110 receives an IP address from the home IP address pool. The DHCP Relay Agent in RAR 130 and the DHCP Server in the RAS 120 are configured for Remote Access by the ISP Configuration Server. If the ISP network is using DSL infrastructure then the configuration protocol can be DSL Forum TR-69.

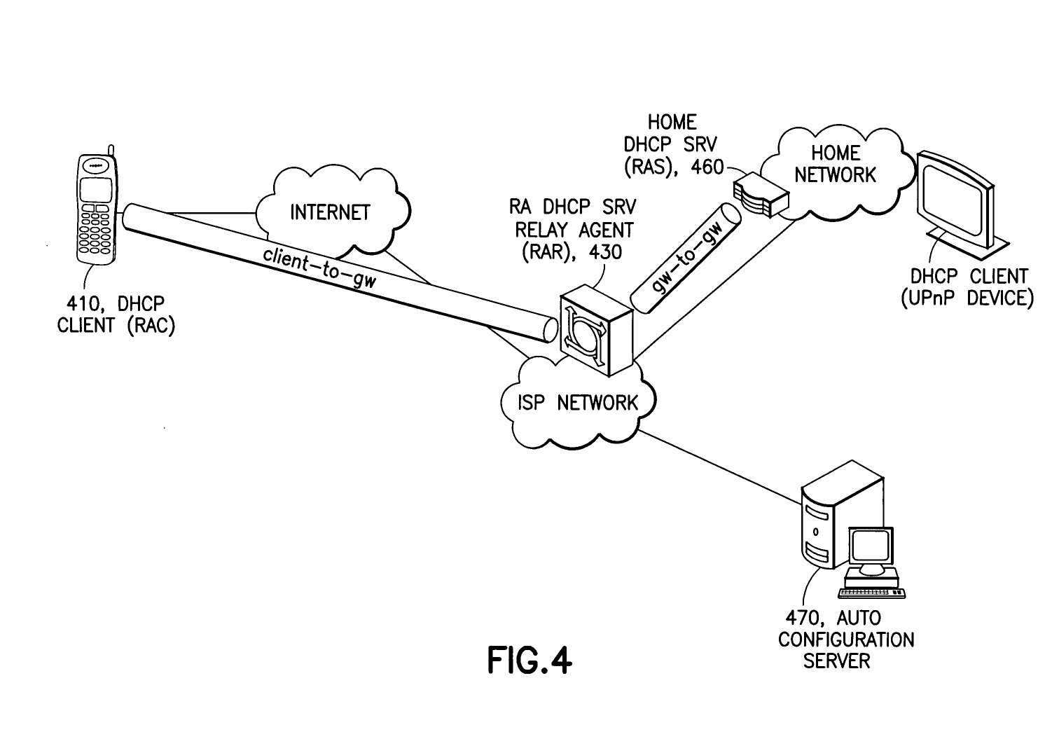

FIG. 4 shows another embodiment of this invention. In FIG. 4, the RAR 430 is acting as a DHCP server and it directly provides the IP addresses from the home IP address pool. As shown in FIG. 4, this DHCP server/RAR 430 may need a special address range. Whenever the DHCP server/RAR 430 receives a DHCP request it allocates an IP address and then it notifies the ISP Auto Configuration Service (ACS) 470 (using, for example, an Inform( ) function defined in TR-69 in the paper “DSL Forum TR-69, CPE Wide Area Network(WAN) Management Protocol”). Then the ACS 470 configures the home DHCP server/RAS 460 so that it adds the IP address allocated to the RAC 410 to the reserved list of IP addresses (using, for example, a SetParameterValue/Attributes( ) function or an AddObject( ) function also defined in TR-69). Using the mechanisms defined in the DSL Forum TR-69 paper helps to keep the DHCP server/RAS 420 and DHCP server/RAR 430 consistent so that no duplicate addresses are allocated to two clients.

The embodiments of this invention create a framework that enables an ISP or a third party service provider to offer a mediation service that enables remote access in situations where direct access is not possible. The foregoing description of address allocation mechanism uses the functions defined in the TR-69 paper as a non-limiting example for a home network that is connected to the Internet via a DSL based infrastructure. For other network infrastructures (for example, a cable modem based home network connected to the Internet) appropriate equivalent mechanisms can be used.

The DSL based embodiments of the exemplary embodiments of this invention have been presented for purposes of illustration and description and are not intended to be exhaustive or to limit the present invention to the precise form disclosed. It is understood that the mechanisms described above can be extended with data models for handling other Remote Access settings and parameters suitable for other network infrastructures (such as cable modem based home network), in light of the above teachings or as may be acquired from practice of the exemplary embodiments of this invention.

The framework described above allows an end user to configure its remote access device(s) regardless the access is direct to its home RAS or mediated by the RAR, hiding the complexity of the service provider infrastructure. The RAS and RAR are configured using the same procedure, with the only difference being a new relay data structure flag that indicates the configurations are updated on the RAR. Non-limiting and exemplary advantages that are gained by the use of the exemplary embodiments of this invention include, but are not limited to:
a. Flexible way to support mediation from third party service providers when it is not possible to connect directly to RAS.
b. Enables the third party service provider to offer advanced/management services to the end users, e.g. access control management, trusted identity provider, etc.
c. The setup process for the RAR-RAC interface and the existence of a RAR on the communication path is transparent for the RAC, e.g. RAC connects to RAR in the same way it connects directly to RAS.
d. Third party service provider can host UPnP services in RAR that are visible to the home UPnP devices as well as to remote UPnP devices
e. Simple and flexible architecture to support multiple access networks infrastructure for the home network, e.g. DSL, cable, etc.
f. Allows some restrictive operators to provide mediated remote access solution for their end user so that they can provide added value services for the RAS-RAR segment (e.g. QoS)

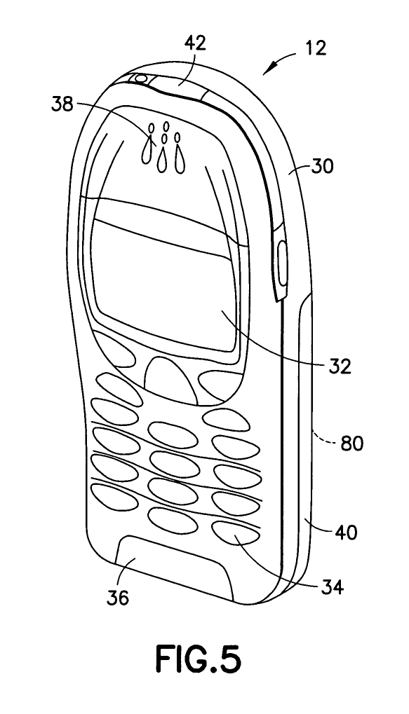

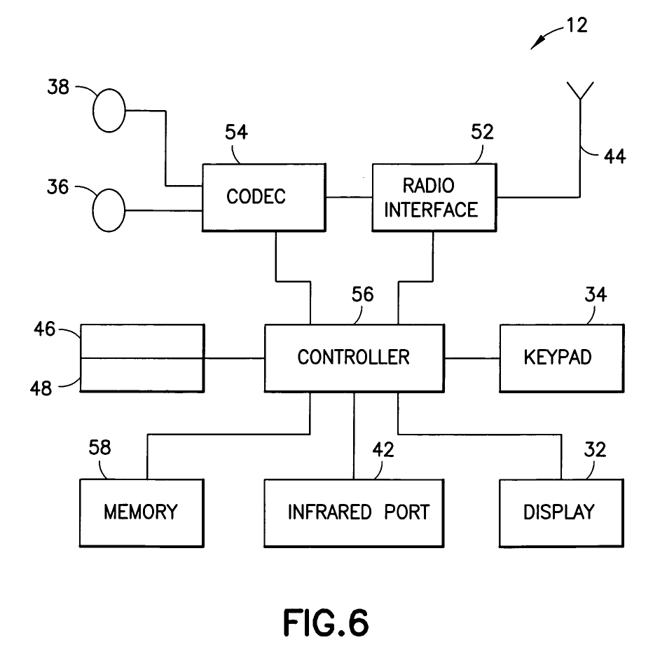

FIGS. 5 and 6 show one representative mobile phone 12 within which the exemplary embodiments of this invention may be implemented. It should be understood, however, that the exemplary embodiments of this invention are not intended to be limited to one particular type of mobile phone 12 or other electronic device such as a combination PDA, an integrated messaging device (IMD), a desktop computer, or a notebook computer. The mobile phone 12 of FIGS. 5 and 6 is composed of various components that may include: a housing 30, a display 32, such as one in the form of a liquid crystal display, a keypad 34, a microphone 36, an ear-piece 38, a battery 40, an infrared port 42, an antenna 44, a smart card 46, a card reader 48, radio interface circuit 52, codec circuit 54, a controller 56 and a memory 58. These individual circuits and elements may all be of a type well known in the art. A high-speed serial interface may be used to implement the communication between any two components in FIG. 6, for example, between the controller 56 and display 32; between the controller 56 and codec 54, and/or between the codec 54 and the radio interface 52.

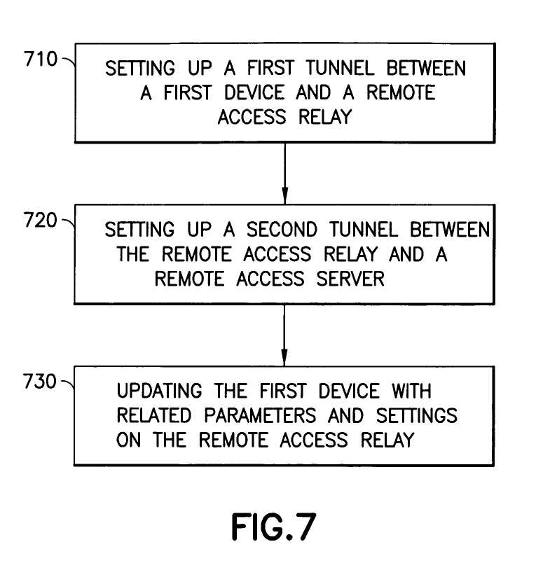

In FIG. 7 there is illustrated a method according to an exemplary embodiment of the invention where there is setting up a first tunnel between a first device and a remote access relay 710, setting up a second tunnel between the remote access relay and a remote access server 720, and updating the first device with related parameters and settings on the remote access relay 730.

Based on the foregoing it can be appreciated that in one aspect thereof the exemplary embodiments of this invention provide a method comprising setting up a first tunnel between a first device and a remote access relay; setting up a second tunnel between the remote access relay and a remote access server; updating the first device with related parameters and settings on the remote access relay; wherein the remote access server is connected to a second device through a network.

In the method of the preceding paragraph, at least one of the first tunnel and the second tunnel can be secure tunnels. Also, at least one of the first device and the second device can be UPnP devices. In addition, the remote access relay can be provided by a third party. Further, the configuration process can be completed according to network management protocol specified in TR-69 by DSL Forum.

The method described in paragraphs can further comprise forwarding DHCP request from the first device to the remote access server. Alternatively, the method can further comprise providing an IP address for the first device and adding the IP address to a reserved list of IP addresses for the network.

Based on the foregoing it can be appreciated that in another aspect thereof the exemplary embodiments of this invention provide a computer program product, embodied in a computer-readable medium, comprising: computer code for setting up a first tunnel between a first device and a remote access relay; computer code for setting up a second tunnel between the remote access relay and a remote access server; computer code for updating the first device with related parameters and settings on the remote access relay; wherein the remote access server is connected to a second device through a network.

In the computer program product of the preceding paragraph, where at least one of the first tunnel and the second tunnel can be secure tunnels. Also, at least one of the first device and the second device can be UPnP devices. In addition, the remote access relay can be provided by a third party. Further, the configuration process can be completed according to network management protocol specified in TR-69 by DSL Forum.

The computer program product described in the preceding paragraphs further comprising computer code for forwarding DHCP request from the first device to the remote access server. Alternatively, the computer program product can further comprise computer code for providing an IP address for the first device and adding the IP address to a reserved list of IP addresses for the network.

Based on the foregoing it can be appreciated that in a further aspect thereof the exemplary embodiments of this invention provide an electronic device comprising: a processor; and a memory unit communicatively connected to the processor and including: executable code for setting up a first tunnel between a first device and a remote access relay; executable code for setting up a second tunnel between the remote access relay and a remote access server; executable code for updating the first device with related parameters and settings on the remote access relay; wherein the remote access server is connected to a second device through a network.

In the electronic device described in the preceding paragraph, at least one of the first tunnel and the second tunnel can be secure tunnels. Also, at least one of the first device and the second device can be UPnP devices. In addition, the remote access relay can be provided by a third party. Further, the configuration process can be completed according to network management protocol specified in TR-69 by DSL Forum.

The electronic device described in the preceding paragraphs can further comprise executable code for forwarding a DHCP request from the first device to the remote access server. Alternatively, the computer program product can further comprise executable code for providing an IP address for the first device and adding the IP address to a reserved list of IP addresses for the network.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Further, it is noted that devices including but not limited to the auto configuration server, the remote access client, the remote access server, the remote access relay, and the auto configuration server are or may be configurable and comprise suitable hardware and/or software for communication and operation of the devices according to the exemplary embodiments or the invention. Such hardware can include but is not limited to a wired or wireless receiver and/or transmitter, a network interface, and any other hardware, circuitry, and software necessary to enable the exemplary embodiments of the invention.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description of the exemplary embodiments of the present invention has been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method, comprising:
setting up a first tunnel between a first device and a remote access relay;
setting up a second tunnel between the remote access relay and a remote access server; and
updating the first device with related parameters and settings on the remote access relay.

2. The method of claim 1, where setting up the first tunnel comprises configuration updates are applied to an interface of the remote access relay that is closest to the first device.

3. The method of claim 2, where the configuration updates include a data structure type relay configuration.

4. The method of claim 3, where the data structure type relay configuration is expressed in extensible markup language (XML).

5. The method of claim 1, wherein after the first tunnel and the second tunnel are set up the remote access server is connected to a second device through the network.

6. The method of claim 1, where at least one of the first tunnel and the second tunnel is a secure tunnel.

7. The method of claim 1, where at least one of the first device and the second device are universal plug and play (UPnP) devices.

8. The method of claim 1, where the remote access relay is operated by a third party different from the first device and the remote access server.

9. The method of claim 1, further comprising forwarding a dynamic host configuration protocol (DHCP) request from the first device to the remote access server via the first and second tunnels.

10. The method of claim 9, where the DHCP request is forwarded by the remote access relay from the first device to the remote access server.

11. The method of claim 1, further comprising providing an internet protocol (IP) address for the first device and adding the IP address to a reserved list of IP addresses for the network.

12. The method of claim 1, where setting up the first tunnel and setting up the second tunnel is transparent to a user of the first device.

13. The method of claim 1 performed when the first device attempts a direct connection to the remote access server.

14. The method of claim 1, where the remote access server can accept or reject setting up the tunnel.

15. A computer readable medium encoded with a computer program executable by a processor to perform actions comprising:
setting up a first tunnel between a first device and a remote access relay;
setting up a second tunnel between the remote access relay and a remote access server; and
updating the first device with related parameters and settings on the remote access relay, wherein the remote access server is connected to a second device through a network.

16. An apparatus, comprising:
a network interface;
a memory; and
a processor configured to set up a first tunnel between a first device and a remote access relay;
the processor further configured to set up a second tunnel between the remote access relay and a remote access server; and
the processor further configured to update the first device with related parameters and settings on the remote access relay.

17. The apparatus of claim 16, where setting up the first tunnel comprises configuration updates are applied to an interface of the remote access relay that is closest to the first device.

18. The apparatus of claim 17, where the configuration updates include a data structure type relay configuration.

19. The apparatus of claim 18, where the data structure type relay configuration is expressed in extensible markup language (XML).

20. The apparatus of claim 16, wherein after the first tunnel and the second tunnel are set up the remote access server is connected to a second device through the network.

21. The apparatus of claim 16, where at least one of the first tunnel and the second tunnel is a secure tunnel.

22. The apparatus of claim 16, where at least one of the first device and the second device are universal plug and play (UPnP) devices.

23. The apparatus of claim 16, where the remote access relay is operated by a third party different from the first device and the remote access server.

24. The apparatus of claim 16, further comprising forwarding a dynamic host configuration protocol (DHCP) request from the first device to the remote access server via the first and second tunnels.

25. The apparatus of claim 24, where the DHCP request is forwarded by the remote access relay from the first device to the remote access server.

26. The apparatus of claim 16, further comprising providing an internet protocol (IP) address for the first device and adding the IP address to a reserved list of IP addresses for the network.

27. The apparatus of claim 16, where setting up the first tunnel and setting up the second tunnel is transparent to a user of the first device.

28. The apparatus of claim 16, where setting up the first tunnel and setting up the second tunnel is performed when the first device attempts a direct connection to the remote access server.

29. The apparatus of claim 16, where the remote access server can accept or reject setting up the tunnel.

30. An apparatus, comprising:
means for setting up a first tunnel between a first device and a remote access relay;
means for setting up a second tunnel between the remote access relay and a remote access server; and
means for updating the first device with related parameters and settings on the remote access relay.

31. The apparatus of claim 24, where the means for setting up the first tunnel, setting up the second tunnel, and updating the first device comprises a processor coupled to a memory and a network interface.
